(19) United States
(12) Patent Application Publication
(10) Pub. No.: US 2025/0391988 A1
(43) Pub. Date: Dec. 25, 2025

(54) CELL HOUSING FOR ACCOMMODATING A BATTERY CELL BODY

(71) Applicant: Hoerbiger Antriebstechnik HoldingGmbH, Schongau (DE)

(72) Inventors: Christian REUMUELLER, Schongau (DE); Manfred KURTH, Schongau (DE); Lukas GREIF, Schongau (DE); Martin SEDLMAIR, Schongau (DE)

(21) Appl. No.: 19/236,051

(22) Filed: Jun. 12, 2025

(30) Foreign Application Priority Data
Jun. 24, 2024 (DE) 102024117730.6

(51) Int. Cl. H01M 50/342; H01M 50/103; H01M 50/119; H01M 50/136

(52) U.S. Cl. CPC H01M 50/3425; H01M 50/119; H01M 50/136; H01M 50/103

(57) ABSTRACT

A cell housing for accommodating a battery cell body includes a closed, circumferential, frame-like peripheral wall made of a flat material. The peripheral wall is formed in one piece and has an overlap section in which an initial section of the peripheral wall and an end section of the peripheral wall overlap and are fastened to each other. The overlap section has a bursting device including a bursting membrane, wherein the bursting membrane has a convex side and a concave side.

### TECHNICAL FIELD

The present disclosure relates to a cell housing for a battery cell body, which has side walls and a bursting device arranged on one of the side walls.

### BACKGROUND

Battery cells, also known as accumulator cells, serve to chemically store electrical energy. One of the best-known battery cells is the lithium-ion battery cell.

Typically, a battery cell comprises at least one battery cell body in the form of an electrode winding or an electrode stack, which in turn is formed from at least one positive electrode, at least one negative electrode, and at least one separator arranged between the positive and negative electrodes. The battery cell body may additionally have an insulating film wrapped around the electrode winding or electrode stack. To form a battery cell, the battery cell body is inserted into a cell housing. Depending on the design of the cell housing, the battery cell is designed as a round cell, a pouch cell, or a prismatic cell.

In lithium-ion batteries, gas formation and resulting overpressure within the battery cell may occur in certain situations, such as a defect or improper handling. It is therefore known to provide a pressure relief valve or a bursting membrane in the cell housing of the battery cell body to discharge the gases produced purposefully in one direction. The bursting membrane is designed to burst at a certain pressure inside the cell housing.

The cell housing of prismatic cells is usually made of aluminum or a material containing an aluminum alloy, and the bursting membrane is directly incorporated into the aluminum cell housing or connected to the cell housing by an intermaterial bond. The bursting membrane is therefore also made of aluminum or a material containing an aluminum alloy. Bursting membranes made of aluminum materials usually have a predetermined breaking point which is subjected to tensile or shear stress and fails in a controlled manner when the tensile strength of the aluminum material is reached, so that the bursting membrane bursts in a controlled manner and pressure equalization can take place between the interior and the exterior of the battery cell.

Alternatively, a cell housing of a prismatic battery cell may also be made of a ferrous material, i.e., iron or a material containing a ferrous alloy. If the bursting membrane is then inserted into the cell housing, it is made of iron or a material containing an iron alloy, just like the cell housing. However, ferrous materials have a significantly higher tensile strength than aluminum, so that a bursting membrane made of iron or an iron alloy also has a significantly higher tensile strength than a comparable bursting membrane made of aluminum or a material containing an aluminum alloy. Consequently, a bursting membrane made of iron is difficult to burst and, in particular, does not burst as quickly and reliably as a comparable bursting membrane made of aluminum. A bursting membrane which is directly inserted or integrated into a cell housing made of iron or a material containing an iron alloy, i.e., is formed in one piece therewith, is difficult to implement technically and economically due to the properties of iron. For this reason, in cell housings made of ferrous materials, bursting membranes are typically inserted as separate components into the cell housing.

in view of above, there is a need is to provide a cell housing having a bursting device which overcomes the disadvantages known from the prior art and ensures reliable bursting of the bursting membrane.

### SUMMARY

Example embodiments relate to a cell housing for accommodating a battery cell body, comprising a closed, circumferential, frame-like peripheral wall made of a flat material. The peripheral wall is formed in one piece and has an overlap section in which an initial section of the peripheral wall and an end section of the peripheral wall overlap and are fastened to each other. The overlap section has a bursting device including a bursting membrane, wherein the bursting membrane has a convex side and a concave side.

The basic idea of the present disclosure is to design the bursting membrane of a cell housing made of iron or a material containing an iron alloy structurally such that, in that the bursting membrane has a convex and a concave side, it can be formed in one piece with the cell housing, i.e., it is also made of iron or a material containing an iron alloy, and yet bursts reliably at an opening pressure of between 2 and 30 bar. The bursting membrane according to the present disclosure does not burst due to a predetermined breaking point subjected to tensile or shear stress, as is possible with a bursting membrane made of aluminum, but due to a failure of the stability of the bursting membrane itself. A predetermined breaking point in the bursting membrane is not absolutely necessary.

The cell housing itself is manufactured from a flat material made of iron or a material containing an iron alloy using a bending, pressing, welding, or roll-forming method. The wall thickness of the flat material forming the peripheral wall has a thickness between 0.2 mm and 3 mm. The reshaping process does not change the wall thickness, so that the cell housing also has a constant wall thickness of 0.2 mm to 3 mm, with the exception of the overlap section in which the initial section and the end section of the peripheral wall overlap. The introduction of this overlap section therefore leads to a stiffening of the cell housing precisely at the side wall in which the bursting device is located. The overlap section gives the cell housing sufficient stability without having to increase the overall wall thickness of the cell housing. This saves material in the manufacture of the cell housing, and the cell housing remains sufficiently stable even after a burst, despite the bursting device.

The initial section is the section which faces with one side towards the interior of the cell housing and at least partially rests against the end section with the other side. In contrast thereto, the end section has one side resting against the initial section, and the opposite side faces towards the outside of the cell housing. In a cross-sectional view, the initial section is therefore located below the end section.

According to the present disclosure, the initial sections and the end sections lying on top of each other in the overlap section are connected to each by an intermaterial bond. Joining methods such as laser welding, friction stir welding or soldering methods are particularly suitable for this purpose. The two sections can be fastened to each other either by welding through from a side of the cell housing resting against the section or by means of a fillet weld. The double or multiple wall in the area of the bursting device stiffens the cell housing particularly effectively at this point.

According to the present disclosure, the bursting membrane is formed in one piece with the initial section, which faces with one side towards the interior of the cell housing. The bursting membrane can therefore be formed directly from the initial section, eliminating the need to insert a separately formed bursting membrane. This prevents a connection point between the separately formed bursting membrane and the cell housing, which weakens the stability of the cell housing and, in the worst case, constitutes an unwanted predetermined breaking point. Rather, the bursting membrane is part of the initial section of the cell housing and thus part of a side wall of the cell housing. In addition, the one-piece design of the bursting membrane with the initial section eliminates a step in the manufacture of the cell housing and reduces the number of separately formed parts. Both of these factors result in time and cost savings in the manufacture of the cell housing.

According to one aspect of the present disclosure, the convex side of the bursting membrane faces towards the interior of the cell housing. In other words, part of an initial section of the cell housing is pressed towards the interior of the cell housing to form the bursting membrane. The bursting membrane produced in this way represents a reverse bursting element, the bursting of which is based on the fact that in case of an increased pressure inside the cell housing, the bursting membrane bursts due to stability failure. As soon as the pressure inside the cell housing rises to an opening pressure of 2 to 30 bar, the bursting membrane is pressed towards the outside of the cell housing until it bursts.

According to a further aspect of the present disclosure, to improve the bursting of the bursting membrane, the bursting membrane may have a weakening zone which is introduced into the material of the peripheral wall, for example by embossing, laser ablation or machining, and which additionally weakens the bursting membrane. In the event of bursting, the bursting membrane and thus part of the peripheral wall bursts precisely at the weakening zone, allowing the gas formed inside the cell housing to escape in a specific manner.

According to the present disclosure, this weakening zone may be a recess which extends over the entire length of the bursting membrane and runs parallel or obliquely to a bending edge of the cell housing. The course of the weakening zone depends on several factors. On the one hand, it is crucial how large the weakening zone must be overall to provide an opening in the event of bursting, which is large enough to dissipate the pressure generated in the cell housing as quickly as possible. On the other hand, the course of the weakening zone also depends on the size of the bursting membrane and the cell housing.

The weakening zone of the bursting membrane may be an inner and/or outer recess with respect to the cell housing. In particular, the recess has a wedge-shaped or trapezoidal cross-section with optional roundings. It is also possible for the weakening zone to be formed on both sides.

The end section, which faces with one side towards the exterior of the cell housing, may have an opening in the area of the bursting device. The opening area of the bursting membrane is 20 to 5,000 mm², so that the opening of the end section must be at least 20 to 5,000 mm² in size. The gases formed inside the cell housing escape to the outside through the opening. Along the opening and thus in the area of the bursting device, the initial section is supported by the end section. It is therefore advantageous if the opening does not extend up to the bending edges of the end section, but rather that at least a small section of the end section can continue to serve as a support for the initial section.

In addition, the bursting device may have a stiffening element in the end section, which is formed in one piece with the end section. The stiffening element serves to stiffen the bursting device in the end section and, especially in the case of a large opening, stabilizes the end section and thus the entire cell housing.

According to a further aspect of the present disclosure, the stiffening element has a bursting aid having a cutting geometry which is assigned to the bursting membrane. The cutting geometry of the bursting aid may be a cutting edge, a cutting surface, and/or a tip. The cutting geometry is formed integrally from the stiffening element, i.e., it is manufactured in one piece from the stiffening element. In particular, the cutting geometry is a cutting edge having a triangular cross-section. The cutting geometry is arranged such that, in the event of bursting, the bursting membrane, if necessary, comes into contact with the cutting geometry of the bursting aid if the bursting membrane has not already burst. For this purpose, the cutting geometry is preferably positioned parallel and offset upwards with respect to the weakening zone of the bursting membrane. Bursting of the bursting membrane is induced at the latest when it comes into contact with the cutting geometry. Advantageously, the cutting geometry is the only part of the bursting aid which comes into contact with the bursting membrane.

The stiffening element may be a web which spans the opening and is spaced apart from the bursting membrane. The web divides the opening into two smaller openings, preferably of equal size, so that the bursting device is overall stabilized. The web preferably divides the opening in halves. In addition, the web serves to provide the bursting aid and is positioned such that the bursting aid preferably runs centrally to the bursting membrane and is located directly above the weakening zone. However, since the web spans the entire opening, the bursting aid can in principle be provided over the entire length of the web. However, it is important that the bursting membrane does not come to rest against the web in the normal state.

In the event of bursting, the bursting membrane has an opening area of 20 to 5,000 mm². The opening pressure, i.e. the pressure which must prevail inside the cell housing for the bursting membrane to burst, is between 2 and 30 bar. The size of the opening area depends on the size of the bursting membrane. The opening pressure may be adjusted, for example, by the type and dimensions of the weakening zone of the bursting membrane or by the degree of convexity of the bursting membrane.

The cell housing may be closed on the front side by a bottom coupled to the peripheral wall and an opposite cover. The connection between the bottom or cover and the cell housing is an intermaterial bond, so that neither the electrolyte solution filled into the cell housing can escape through the weld seam nor can other substances penetrate into the battery cell via the weld seam.

Both the bottom and the cover may have the two poles required for a battery. Either the cover can have both poles or one pole is located in the cover and a second pole is located in the bottom.

The cell housing according to the present disclosure may be manufactured using the following five-step method.

In a first step, a flat plate made of flat material is provided. The plate may be made of any metal material, but is in particular made of iron or a material containing an iron alloy.

In a second step, the first part of the bursting device is formed. For this purpose, the opening is formed in the end section of the peripheral wall, wherein the stiffening element is formed in one piece with the end section so that it divides and preferably halves the opening. The bursting aid is additionally formed on the stiffening element and shaped therefrom.

In a third step, the second part of the bursting device is formed. The bursting membrane is formed from the initial section of the peripheral wall. It is advantageous if the bursting membrane is located completely within the opening in the assembled state of the cell housing, i.e., if it is not larger than the opening. The bursting membrane is inserted into the initial section of the peripheral wall such that the convex side of the bursting membrane faces towards the future interior of the cell housing. The concave side accordingly faces towards the end section and the exterior of the cell housing.

Of course, it is also possible to form the bursting membrane first and to form the opening and the stiffening element in a third step.

In a fourth step, the plate is formed into the closed, circumferential, frame-like peripheral wall. To do this, the plate is reshaped at at least four points so that at least four bending edges are created. The bending edges have a bending radius of 0.1 mm to 10 mm at a bending angle of 90°. After bending, the initial section and the end section of the peripheral wall overlap at least partially and together form the overlap section with the bursting device. The wall thickness in the overlap section, with the exception of the bursting device, is therefore twice as large as the wall thickness of the remaining cell housing. The housing may be either bent, roll-formed, extruded or stack-pressed. In particular, however, it is bent or produced as an endless tube by roll-forming.

In a fifth step, the initial section and the end section are at least partially connected to each other by an intermaterial bond in the overlap section by a joining process. Possible joining processes are laser welding or friction stir welding, so that a fillet weld is formed. If the initial section and the end section overlap to such an extent that one of the two sections contacts a second side wall, this section can be fastened to the adjacent housing side by welding through. The connection can also be made over the entire surface in the entire overlap section, for example by soldering.

To produce a finished battery cell, the battery cell body is inserted into the cell housing after manufacture of the cell housing. A bottom and a cover are fastened to the peripheral wall, for example by laser or ultrasonic welding, to form a closed cell housing. An electrolyte solution is then introduced.

### BRIEF DESCRIPTION OF THE DRAWINGS

Further features and advantages of the present disclosure will become apparent from the description below and from the accompanying drawings, to which reference is made and in which:

FIG. 1 shows an isometric view of a cell housing according to an example embodiment with a bursting device;

FIG. 2 shows a top view of the bursting device of FIG. 1;

FIG. 3 shows a cross-sectional view of the bursting device of FIG. 1; and

FIGS. 4a and 4b show a cross-sectional view of a cell housing according to an example embodiment of the present disclosure.

### DETAILED DESCRIPTION

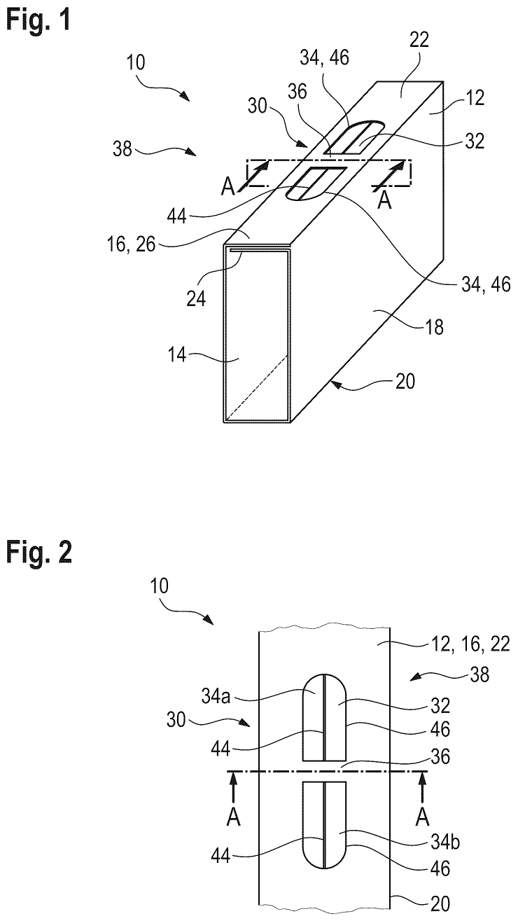

FIG. 1 shows a cell housing 10 for a battery cell body, which is configured as a prismatic cell housing.

The cell housing 10, more precisely the peripheral wall 12 shown of the cell housing 10, is formed from a reshaped flat material. In principle, all common metal materials can be used as flat material, for example iron or a material containing an iron alloy.

The peripheral wall 12 is made in one piece from the flat material by reshaping, in particular bending or roll-forming.

The peripheral wall is closed circumferentially and configured like a frame so as to enclose an interior 14 of the cell housing 10. A battery cell body can be inserted into the interior 14 at a later stage.

The cell housing 10 has a rectangular cross-section with two short, opposite sides 16 and two long, opposite sides 18, which are respectively parallel to each other. The two sides 16, 18 can be of any length, as long as the two short sides 16 and the two long sides 18 are respectively substantially equal in length, so that a prismatic cell housing 10 is produced.

A bending edge 20 having a bending radius r of between 0.2 mm and 10 mm is located between two adjacent sides 16, 18. To prevent unnecessarily high material stress, the bending edge 20 is not a sharp edge, but a blunt edge.

The short sides 16 and the adjacent long sides 18 enclose a bending angle a of substantially 90° in a rectangular cross-section.

Parts of the peripheral wall 12 overlap at one of the two short sides 16 and form an area in which the peripheral wall 12 is reinforced on one side. This area represents an overlap section 22.

Strictly speaking, the overlap section 22 is formed from an initial section 24 and an end section 26 of the peripheral wall 12.

The initial section 24 is arranged on the side of the cell housing 10 which faces the interior 14 and forms the inner layer, and the end section is located on the side of the cell housing 10 which faces away from the interior 14 and forms the outer layer of the cell housing 10.

The entire overlap section 22 constitutes more than 90% of the area of the short side 16. Therefore, almost the entire short side 16 is stiffened by the overlap section 22.

In the cell housing 10 illustrated in FIG. 4b, the initial section 24 even extends beyond the short side 16 and contacts the adjacent long side 18.

To give the cell housing 10 the necessary stability, the initial section 24 and the end section 26 are connected to each other by an intermaterial bond at at least two fastening points 28. For this purpose, the two sections 24 and 26 are laser-welded or friction stir-welded, for example. The resulting weld seam is designed, for example, as a fillet weld. If the initial section 24 is longer than the short side 16 or the long side 18 and contacts the adjacent side 16, 18, the initial section 26 can also be fastened to a short side 16 or a long side 18, for example by through welding, as shown in FIG. 4b.

The peripheral wall 12 is formed from a flat material having a constant wall thickness w1. Since the peripheral wall is formed in one piece from the flat material, the cell housing 10 also has the constant wall thickness w1 in most areas. The cell housing 10 has a different wall thickness w2 only in the overlap section 22. Due to the overlapping of the initial section 24 and the end section 26 of the cell housing, the wall thickness w2 in the overlap section 22 is twice as large as the wall thickness w1. This results in a one-sided reinforcement and stiffening of the cell housing 10.

This stiffening is necessary because, for safety reasons, a bursting device 30 is provided in the overlap section 22 of the cell housing 10.

The bursting device 30 is incorporated into one of the two short sides 16 and includes a bursting membrane 32 and an opening 34 over which a stiffening element 36 spans.

The bursting membrane 32 is designed to burst in the event of bursting and to allow pressure equalization between the interior 14 and an exterior 38 of the cell housing 10.

The bursting membrane 32 is formed in one piece with the initial section 24 of the peripheral wall 12 and thus forms part of the peripheral wall 12 of the cell housing 10. Strictly speaking, the bursting membrane 32 is formed from the initial section 24 so that it has a curved structure with a concave side 40 and a convex side 42.

The concave side 40 faces towards the exterior 38 of the cell housing 10, and the convex side 42 faces towards the interior 14 of the cell housing 10.

This geometric design of the bursting membrane 32 allows the bursting membrane 32 to burst at an opening pressure between 2 and 30 bar, even if the bursting membrane 32 is made of iron or a material containing an iron alloy. The bursting of the bursting membrane 32 is based on the principle of stability failure, since the bursting membrane 32 bursts due to stability failure. For this reason, the bursting membrane 32 is a reverse bursting element. In the event of bursting, the cell housing 10 has an opening area of between 20 and 5,000 mm², depending on the size of the bursting membrane 32.

The bursting membrane 32 also has a weakening zone 44, which constitutes the kind of predetermined breaking point for the bursting membrane 32.

This weakening zone 44 makes it easier for the bursting membrane 32 to burst when the opening pressure is applied in the interior 14 of the cell housing 10. The opening area of the bursting membrane 32 can additionally be influenced by the design and size of the weakening zone 44.

As can be seen particularly well in FIG. 2, the weakening zone 44 is designed as an indentation having a wedge-shaped cross-section. The weakening zone 44 is located in the bursting membrane 32 and thus in the initial section 24 of the peripheral wall 12 and is located on the side of the end section 26 which faces away from the interior 14.

Of course, the weakening zone 44 can also be arranged on the side of the end section 26 which faces the interior 14. Two weakening zones 44 are also possible, wherein one weakening zone 44 can be arranged on the side facing away from the interior 14 and the second weakening zone 44 can be arranged on the side of the end section 26 facing the interior 14.

The end section 26 has an opening 34 opposite the bursting membrane 32 as a counterpart to the bursting membrane 32, so that all elements together constitute the bursting device 30.

The opening 34 is shaped such that, when viewed in a top view, the bursting membrane 32 lies completely within the opening 34, so that the opening 34 completely encloses the bursting membrane 32.

As shown in FIGS. 1 and 2, the opening 34 has an oval-shaped outer rim 46 consisting of two circular arcs and two straight lines. However, the outer rim 46 of the opening 34 can have any geometric shape as long as it completely encloses the bursting membrane 32.

Laterally, the opening 34 is spaced on all sides from the bending edges 20 of the peripheral wall 12. The opening 34 is thus completely enclosed by the end section 26 and thus by the peripheral wall 12.

The entire outer rim 46 of the opening 34 and the remaining part of the end section 26 are in contact with the underlying initial section 24 of the peripheral wall 12, both sections 24, 26 together forming the bursting device 30. The initial section 24 and the end section 26 are supported against each other in the rim areas of the bursting device 30 to ensure the stability of the cell housing 10 despite the bursting device 30.

As additional stabilization, especially of the end section 26, the stiffening element 36, which is formed in one piece with the end section 26, extends over the opening 34 of the end section 26.

The stiffening element 36 is designed as a kind of web.

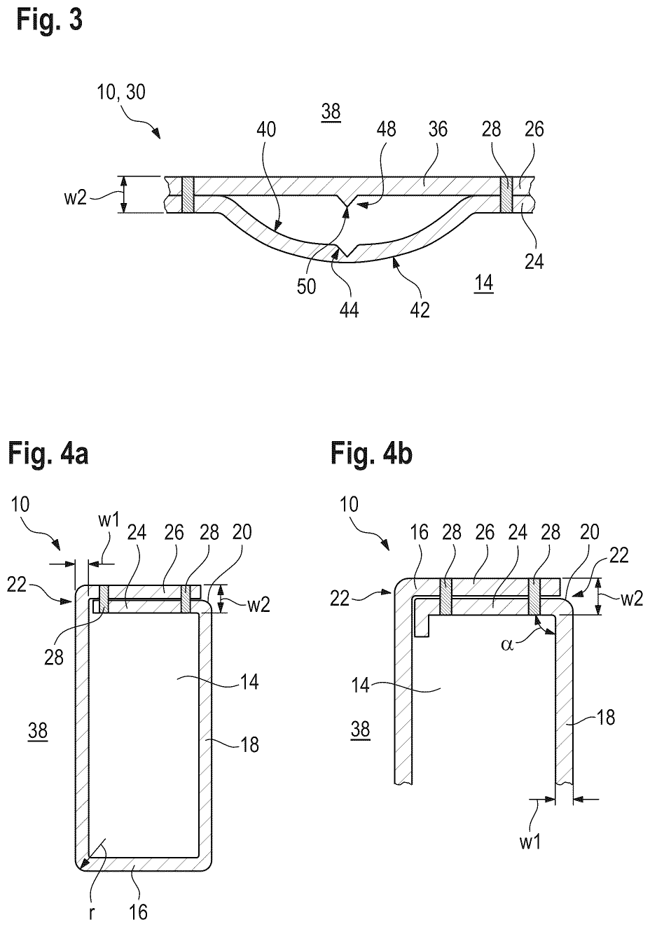

As can be seen in FIG. 3, the stiffening element 36 can be arranged in one plane with the end section 26, i.e., it does not protrude either towards the interior 14 or towards the exterior 38. In addition, the stiffening element 36 is spaced apart from the bursting membrane 32 so that the bursting membrane 32 does not come to rest against the stiffening element 36 in the normal state, at a normal pressure inside the cell housing 10.

This is particularly important to maintain the function of the bursting membrane 32 as a reverse bursting element on the one hand, and because the stiffening element 36 provides a bursting aid 48 with a cutting geometry, on the other hand.

The bursting aid 48 serves to cause the bursting membrane 32 to burst in the event of bursting, if it has not already burst. The bursting aid 48 must therefore be able to weaken the bursting membrane 32 structurally such that the bursting membrane 32 breaks at least at one point to allow gas exchange between the interior 14 and the exterior 38 of the cell housing 10.

The bursting aid 48 is located substantially in the center of the stiffening element 36 and has a wedge-shaped cross-section which is assigned to the bursting membrane 32.

To ensure reliable bursting of the bursting membrane 32, the bursting aid 48 has a cutting geometry 50 which is assigned to the bursting membrane 32 and against which the bursting membrane 32 may come to rest in the event of bursting.

The cutting geometry 50 arranged on the bursting aid 48 can basically be a cutting edge, a cutting surface, and/or a tip.

As is particularly well shown in FIG. 3, the cutting geometry 50 is a cutting edge which protrudes from a plane formed by the stiffening element 36 towards the bursting membrane 32, i.e., it faces the bursting membrane 32 and is assigned thereto. The cutting geometry 50 is preferably located directly above the weakening zone 44 of the bursting membrane 32 and runs parallel thereto, offset upwards. The cutting geometry 50 and the bursting aid 48 thus run parallel to the bending edges 20 of the cell housing 10 and perpendicular to the stiffening element 36.

The bursting aid 48 with the cutting geometry 50 is formed in one piece from the stiffening element 36, which in turn is formed in one piece with the end section 26.

Thus, all parts of the bursting device 30 are formed in one piece with the cell housing 10.

A method of manufacturing the cell housing 10 as shown in FIGS. 1 to 4 is described below.

In a first step, a flat plate made of flat material consisting of iron or a material containing an iron alloy is provided.

In a second step, it is provided to insert a bursting membrane 32 into the initial section 24. An opening 34 which is opposite the bursting membrane 32 in the assembled cell housing is formed at the end section 26 so that, when viewed in a top view, the bursting membrane 32 is located within the opening 34 in the assembled state. When introducing the opening 34, the stiffening element 36 with the bursting aid 48 and the cutting geometry 50 is at the same time formed from the end section 26.

In a third step, this flat plate is reshaped to form a closed, circumferential, frame-like peripheral wall 12. This closed peripheral wall 12 with the overlap section 22 is particularly clearly visible in FIGS. 4a and 4b.

In FIG. 4a, only one of the sides 16, 18 of the cell housing 10, namely a short side 16, includes the overlap section 22, while in FIG. 4b, the overlap section 22 also extends partially over the long side 18.

This peripheral wall 12 is formed in one piece from the plate. Various methods for mechanically reshaping metals, such as flow pressing, extrusion, bending, or roll-forming, can be used to reshape the plate. The bending angle a when bending the plate is substantially 90°. Overall, the plate is bent at least four times so that at least four bending edges 20 are formed. The bending radius r of each bending edge 20 is between 0.2 mm and 10 mm. The plate is bent such that the initial section 24 and the end section 26 of the peripheral wall 12 overlap in the overlap section 22, thereby achieving a one-sided stiffening of the cell housing 10. This results in a wall thickness w2 in the overlap section 22 which is twice as large as the wall thickness w1 of the remaining cell housing 10.

In a fourth step, the initial section 24 and the end section 26 are connected to each other at least partially in the overlap section 22 by an intermaterial bond to establish the stability of the cell housing 10. Laser welding, friction stir welding or similar welding methods or soldering methods are particularly suitable for this purpose. This means that the overlap section 22 has fastening points 28 at which the initial section 24 and the end section 26 are connected to each other, which are either achieved by welding through from an adjacent side or are designed as fillet weld. The fastening points 28 can therefore be either point-shaped or planar.

After the cell housing 10 has been manufactured, a battery cell body can be inserted into the interior 14 of the cell housing 10 so that a battery having a cell housing 10 with a bursting device 30 is formed.

While the present disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A cell housing for accommodating a battery cell body, comprising:
a closed, circumferential, frame-like peripheral wall made of a flat material,
wherein the peripheral wall is formed in one piece and has an overlap section in which an initial section of the peripheral wall and an end section of the peripheral wall overlap and are fastened to each other, and
wherein the overlap section has a bursting device including a bursting membrane, wherein the bursting membrane has a convex side and a concave side.

2. The cell housing of claim 1, wherein the bursting membrane is formed in one piece with the initial section which faces with one side towards an interior of the cell housing.

3. The cell housing of claim 1, the convex side of the bursting membrane faces towards the interior of the cell housing.

4. The cell housing of claim 1, wherein the bursting membrane has a weakening zone.

5. The cell housing of claim 4, the weakening zone is a recess.

6. The cell housing of claim 1, wherein the end section, which faces with one side towards an exterior of the cell housing, has an opening in the area of the bursting device.

7. The cell housing of claim 1, wherein the bursting device has a stiffening element in the end section, which is formed in one piece with the end section.

8. The cell housing of claim 7, wherein the stiffening element has a bursting aid having a cutting geometry which is assigned to the bursting membrane.

9. The cell housing of claim 7, wherein the stiffening element is a web which spans the opening and is spaced apart from the bursting membrane.
